(19) United States
(12) Patent Application Publication
(10) Pub. No.: US 2019/0302221 A1
(43) Pub. Date: Oct. 3, 2019

(54) FOG-BASED INTERNET OF THINGS (IOT) PLATFORM FOR REAL TIME LOCATING SYSTEMS (RTLS)

(71) Applicant: IOT EYE, INC., Piscataway, NJ (US)

(72) Inventors: Ming-Jye SHENG, Basking Ridge, NJ (US); Shucheng SHANG, Metuchen (CA); Cong ZHANG, Somerset, NJ (US); Christine ChihLing SHENG, Basking Ridge, NJ (US)

(73) Assignee: IOT EYE, INC., Piscataway, NJ (US)

(21) Appl. No.: 16/348,206

(22) PCT Filed: Nov. 8, 2017
(86) PCT No.: PCT/US17/60513

§ 371 Date: May 8, 2019

Related U.S. Application Data
(60) Provisional application No. 62/419,346, filed on Nov. 8, 2016.

(51) Int. Cl. G01S 5/02; H04W 4/33; H04W 4/029; G01S 11/06

(52) U.S. Cl. CPC G01S 5/0252; H04W 4/33; G01S 11/06; G01S 5/0242; H04W 4/029

(57) ABSTRACT

A Real-Time Locating System (RTLS) and method for determining real-time spatial coordinates of a user device (UD), and a method for acquiring data associated with the UD are disclosed. Additionally, a method for characterizing data associated with the UD is disclosed. Strategic placement of one or more agents and machine learning algorithms are used in acquiring and processing the data to calculate the real-time location of the UD.

This application is a national phase filing under 35 U.S.C. 371 of International Patent Application No. PCT/US2017/060513 filed on Nov. 8, 2017, which claims the benefit to U.S. Provisional Application No. 62/419,346, filed on Nov. 8, 2016, which application is incorporated herein by reference as if set forth in its entirety.

### FIELD OF THE INVENTION

The present invention relates generally to the field of Internetofthings (IoT), and more particularly to System and Methods for Real Time Locating of User Devices (UD).

### BACKGROUND OF THE INVENTION

The Internet of Things (IoT) is the internetworking of physical devices and connected devices namely, smart devices, buildings, homes, parking meters, light bulbs, cars, and other objects embedded with electronics, firmware/software, sensors, actuators and network connectivity that enable these items to collect and exchange data. The IoT allows objects to be sensed and/or controlled remotely across existing network infrastructure creating opportunities for more direct integration of the physical world into computer-based systems, and resulting in improved efficiency, accuracy and economic benefit. When IoT is augmented with sensors and actuators, the technology becomes an instance of the more general class of cyber-physical systems, which also encompasses technologies such as smart grids, smart homes, intelligent transportation and smart cities. Each thing is uniquely identifiable through its embedded computing system but is able to interoperate within the existing Internet infrastructure.

### SUMMARY OF THE INVENTION

Various embodiments provide a real-time locating system (RTLS) for determining real-time spatial coordinates of a user device (UD) and method for acquiring data associated with the user device. Moreover, the present embodiments provide a method for characterizing data associated with the UD. Finally, strategic placement of one or more agents and machine learning algorithms are used in acquiring and processing the data to calculate the real-time location of the UD.

In one embodiment, a system is provided. The system comprises one or more agents optimally located in an area of an environment to thereby map the spatial coordinates of the particular environment and correlate the location of the one or more agents associated with the particular environment, said one or more agents communicatively coupled to a first routing device; one or more fogs communicatively coupled to the first routing device and configured with a non-transitory computer readable medium having stored thereon instructions that, upon execution by a central processing engine, cause the central processing engine to execute one or more applications associated with the one or more fogs to determine real-time spatial coordinates of a user device, thereby enabling said one or more fogs to: (a) process characterization data associated with one or more user devices to thereby perform data mining of the one or more user devices and assign at least a tag to each of the one or more user devices; (b) transmit one or more commands towards the one or more agents; (c) receive from the one or more agents data associated with a specific user device; (d) normalize the data of the specific user device to thereby determine the real-time spatial coordinates based on the corresponding data associated with said user device; and (e) transmit one or more commands towards a cloud server communicatively coupled to the fog via a second routing device.

Another embodiment provides a method for acquiring data associated with a user device. The method includes the steps of: sensing a wireless signal transmitted towards one or more agents, said wireless signal associated with one or more beacons; processing characterization data associated with the one or more user devices and identify a respective tag associated with each of said one or more user devices; processing one or more commands a fog transmits towards the one or more agents; measuring a signal strength of said wireless signal and associating relative spatial coordinates to the corresponding data associated with a specific user device whose signal was measured; transmitting toward the fog the data for the specific user device to thereby determine the real-time spatial coordinates of the specific user device.

Yet, another embodiment provides a method for determining real-time spatial coordinates of a user device. The method comprises the steps of determining for a particular environment, the optimal placement of one or more agents to thereby map the spatial coordinates of the particular environment and correlate the location of the one or more agents associated with the particular environment; processing characterization data associated with one or more user devices to thereby perform data mining of the one or more beacons and assign at least a tag to each of the one or more beacons; transmitting one or more commands towards the one or more agents; receiving from the one or more agents data associated with a specific user device; normalizing the data of the specific user device to thereby determine the real-time spatial coordinates based on the corresponding data associated with said user device; and transmitting one or more commands towards the cloud server.

A further method provides for characterizing data associated with a user device. The method comprises the steps of: receiving characterization sync signal data transmitted towards the cloud server; processing characterization data associated with one or more user devices to update the data based on user device security policy; transmitting toward a fog updated characterization data sync signal to thereby determine the real-time spatial coordinates of a specific user device based on the corresponding data of said user device; and receiving zone data associated with one or more user devices and archiving the data.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system benefiting from embodiments of the present invention;

FIG. 2 depicts a high-level block diagram of an implementation according to the system of FIG. 1;

FIG. 3 depicts a high-level block diagram of an implementation according to the system of FIG. 1;

FIG. 4 depicts a network of fogs from different locations linked together to the cloud;

FIG. 5 depicts an exemplary Movement Factor implementation according to the system of FIG. 1;

FIG. 6A depicts a Flow Chart of a process for implementing the Training Model Optimization algorithm according to an embodiment of the invention;

FIG. 6B depicts a Flow Chart of a process for implementing the Generate Training Model (Support Vector Model (SVM)) algorithm according to an embodiment of the invention;

FIG. 6C depicts a Flow Chart of a process for implementing the Generate Training Model (Artificial Neural Network (ANN)) algorithm according to an embodiment of the invention;

FIG. 6D depicts a Flow Chart of a process for implementing the Training Model Calibration algorithm according to an embodiment of the invention;

FIG. 6E depicts a Flow Chart of a process for Updating the procedure in implementing the Training Model Calibration algorithm according to an embodiment of the invention;

FIG. 6F depicts a Flow Chart of a process for the retrain procedure in implementing the Training Model Calibration algorithm according to an embodiment of the invention;

FIG. 6G depicts a Flow Chart of a process for real-time room/zone decision in implementing the Training Model Calibration algorithm according to an embodiment of the invention;

FIG. 6H depicts a Flow Chart of a process for Received Signal Strength Indication (RSSI) data collection in implementing the algorithm according to an embodiment of the invention;

FIG. 7A depicts a Star Based Arrangement of an implementation according to the system of FIG. 1;

FIG. 7B depicts a Layer Star Based Arrangement of an implementation according to the system of FIG. 1;

FIG. 8 depicts a Corner Based Arrangement of an implementation according to the system of FIG. 1;

FIG. 9A depicts a Star Based Arrangement of an implementation according to the system of FIG. 1;

FIG. 9B depicts a Layer Star Based Arrangement of an implementation according to the system of FIG. 1;

FIG. 10 depicts Data Collection for Corner Based Arrangement of an implementation according to the system of FIG. 1;

FIG. 11 depicts a Flow Chart of a process for determining real-time data in implementing the algorithm according to an embodiment of the invention;

FIG. 12 depicts a Flow Chart of a process for acquiring data in implementing the algorithm according to an embodiment of the invention; and

FIG. 13 depicts a Flow Chart of a process for characterizing real-time data in implementing the algorithm according to an embodiment of the invention.

To facilitate understanding, identical reference numerals have been used to designate elements having substantially the same or similar structure and/or substantially the same or similar function.

### DETAILED DESCRIPTION OF THE INVENTION

Various embodiments provide a system for determining real-time spatial coordinates of a user device (UD) and method for acquiring data associated with the user device. The disclosed architecture is a Fog network based architecture that uses user devices, e.g., beacons, multiple agents and fog nodes to carry out processing for RTLS (Real Time Location System). For example, below listed are some functions used in achieving the objectives articulated above.

### Use of the General Purpose Monitor System (GPMS) as a Locating and Tracking System

In the GPMS, the user device is a wireless device such as a Beacon or a Bluetooth device, which periodically transmits Identification Code.
This Identification Code, together with the measured Radio Signal Strength Indicator (RSSI) by which the ID code is transmitted, is processed in the Computer Processing Center, e.g., fog.
By method of Triangulation, and/or Mapping, if a fingerprint diagram is available, the location of the UD is derived.

### Accuracy Enhancement Methods of the Locating and Tracking System

Use of a specific Agent placement layout with omni antennas.
Use of machine learning models for training model and calibration to adapt to environment changes.
Use of additional room/zone decision logic.

### Use of Reference User Device (RUD):

A Reference User Device (RUD) such as a Beacon, is placed in a known location. The RSSI of the RUD, as picked up by the Detectors, along with the RUD location information, is used for calibration of distance and location and used as standard reference.
Any RSSI picked up thereafter from any UD, is compared with the calibration reference standard, and is adjusted accordingly when translating it to location.
Use of the multi-room decision algorithm to eliminate locating error.

### Use of the Multi-Sense as a Locating, Tracking and Unusual Events Monitoring System

In this system, the agent, in addition to being a transceiver, also detects unusual events of the wearer or User Device (UD). Examples of such unusual events are fall detection, negligent supervision care, etc.

The agent, having established connection with the fogs, transmits unusual events as digital signal to the Computer Processing Center via the gateway and router. The application software discerns the information for prompting health care actions. In some embodiments, the computer processing center is distinct and a stand-alone element of the network. In other embodiments, the computer processing center resides within the individual fog.

In the preferred embodiment, user device (UD) 105-115 periodically transmits its identification code (ID). This ID is processed together with the radio signal strength by which the ID code is transmitted. The location of the UD is derived by the method of triangulation and/or fingerprint diagram. The accuracy of the RLTS is enhanced with the use of a specific agent placement equipped with omni antennas. Machine learning models as training model and calibration are used to adapt to environment changes augmented by room/zone decision logic.

The illustrative system and method embodiments described herein are not meant to be limiting. It may be readily understood that certain aspects of the disclosed system and methods can be arranged and combined in a variety of different configurations, all of which are contemplated herein.

Generally speaking, any computing device such as a cellular telephone or smart phone or any computing device having similar functionality may implement the various embodiments described herein. In various embodiments, any Internet enabled device such as personal digital assistant (PDA), laptop, desktop, end-user clients, near-user edge devices, electronic book, tablets and the like capable of accessing the Internet may implement the various embodiments described herein. While computing devices are generally discussed within the context of the description, the use of any device having similar functionality is considered to be within the scope of the present embodiments.

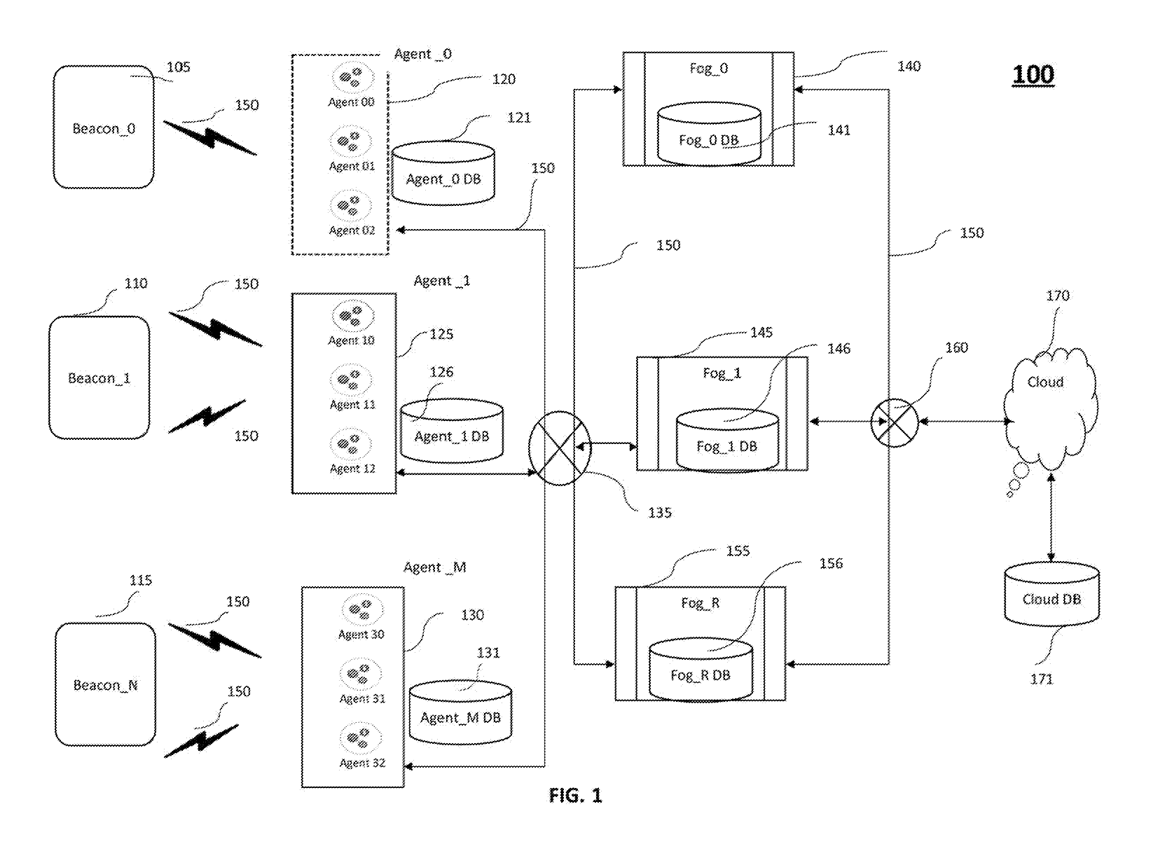

Referring now to the figures, FIG. 1 is a simplified block diagram of a system 100, according to an exemplary embodiment herein described. Real Time Locating System 100 is comprised of a set of fixed beacon receivers at known locations and a moving beacon transmitter such as mobile tag or a mobile phone generally referred to herein as a user device. Moving beacon transmitters transmit constant wireless signals to the fixed beacon receivers whose locations are known. This constant wireless signals from moving beacons to the Agents (Beacon Receivers) provide raw data information such as Identification code, Radio Signal Strength, etc. By combining the Radio Signal Strength and the known Agent (fixed beacon receiver) locations, and using algorithms such as triangulation, or machine learning, the location of the moving Bluetooth Beacon can be calculated.

Examples of deployment of such a system include: tracking equipment/assets in hospital, tracking shopping cart movement in a mall, tracking package movement in a warehouse, finding missing children in a shopping mall, tracking worker's movements to improve operational efficiency, and the like.

In one embodiment, user device (UD) 105-115 is a wearable and/or attachable device, mobile and/or portable device, which is wirelessly transmitting self-generated data as well as code for self-identification. For example, UDs include Beacon, WiFi®, RFID (Radio-frequency identification—uses electromagnetic fields to automatically identify and track tags attached to objects), Apple watch, Fitbit™, 4G/5G devices, LTE devices and all wireless digital transceivers. UD 105-115 is generally a mobile tag that transmits identification signal periodically and as a result interacts with Agent 120, 125, 130 via link 150. In addition to being a transceiver, UD 105-115 also detects unusual events of the wearer or user. Examples of such unusual events are fall detection, negligent supervision care, etc. This type of UD transmits unusual events as digital signal to the Computer Processing Center (Fog) via the gateway and router when connection is established with the detectors or agents. The application software discerns the information for prompting health care actions.

In one embodiment, link 150 extends over great distance and is a cable, a USB cable, satellite or fiber optic link, radio waves, a combination of such links or any other suitable communications path. In various embodiments, link 150 extends over a short distance. In one embodiment, link 150 is unlicensed radio frequency where both user devices 105-115 and digital capturing devices or agent 120-130 reside in the same general location. In another embodiment, link 150 is a network connection between geographically distributed systems, including network connection over the Internet. In other embodiments, link 150 is wireless. In other embodiments, the use of any system having similar functionality is considered to be within the scope of the present embodiments. In various embodiments, link 150 is a WiFi® system. In other embodiments, link 150 is Ethernet based communication system. In various embodiments, link 150 supports mobile services within an LTE network or portions thereof, those skilled in the art and informed by the teachings herein will realize that the various embodiments are also applicable to wireless resources associated with other types of wireless networks (e.g., 4G networks, 3G networks, 2G networks, WiMAX, etc.), wireline networks or combinations of wireless and wireline networks. Thus, the network elements, links, connectors, sites and other objects representing mobile services may identify network elements associated with other types of wireless and wireline networks. In other embodiments, the use of any wireless system having similar functionality is considered to be within the scope of the present embodiments.

In various embodiments, device 120-130 are detectors or wireless transceivers such as Bluetooth transceiver, WiFi® transceiver, 4G, 5G and LTE devices. Device or agent 120-130 continuously monitor signal strength (RSSI) of user device (UD) 105-115 in its Whitelist, and multi-sense signals (vision, speech, temperature, humidity, etc.) from environment. In some embodiments, device or agent 120-130 are fixed. In other embodiments, device or agent 120-130 are mobile. In various embodiments, any Internet enabled device such as personal digital assistant (PDA), laptop, desktop, electronic book, tablets and the like capable of accessing the Internet is used as device 120-130. In one embodiment, device or agent 120-130 is a transducer. In other embodiments, device or agent 120-130 is configured with one or more transceivers arranged as one IoT (Internet of Things) sensor coupled to an omni antenna receiver. Device or agents 120-130 are configured with at least a beacon signal measurer, a beacon address scanner, an agent whitelist, an agent blacklist and a multi-sense sensor. In some embodiment, an omni antenna is used.

Device or agents 120-30 are associated with (Data Base) DB 121, 126 and 131 respectively. DB 121, 126 and 131 store data generated and used by device or agent 120-30. DB 121, 126 and 131 are used to store data designated as Whitelist data and Blacklist data. Whitelist data includes addresses (such as MAC addresses) of UD (user devices) that are considered acceptable and are therefore not filtered out. Blacklist data refers to a list of denied entities, ostracized or unrecognized for access to cloud 170 or fog 140-155 resources.

In various embodiments, Fog 140-155 includes end-user clients, near-user edge devices to carry out a substantial amount of storage (rather than stored primarily in cloud data centers), communication (rather than routed over backbone networks), and control, configuration, measurement and management (rather than controlled primarily by network gateways such as those in the LTE core). Fog 140-155 aggregate measurements from device or agent 120-130 to provide real time tracking processing (spatial coordinate estimation, room/zone decision and unusual events).

Fog 140-155 serves web pages, as well as other web-related content, such as Java, Flash, XML, and so forth. Fog 140-155 may provide the functionality of receiving and routing messages between networking agent 120-130 and cloud 170, for example, whitelist data, blacklist data, UD MAC addresses and the like. Fog 140-155 may provide API functionality to send data directly to native client device operating systems, such as iOS, ANDROID, webOS, and RIM. The Web server may also serve web pages including question and votes via the network 150 to user devices 105. Alternatively, the web server may also render question and votes in native applications on user devices 105-115. In one embodiment, a web server may render question on a native platform's operating system, such as iOS or ANDROID, to appear as embedded advertisements in native applications.

In various embodiments, Fog 140-155 is a smart phone, cellular telephone, personal digital assistant (PDA), wireless hotspot or any internet-enabled device including a desktop computer, laptop computer, tablet computer, and the like capable of accessing the Internet may be used in terms of Fog 140-155.

In various embodiments, Fog 140-155 are configured as a local area network where both agent 120-130 and fog 140-155 reside in the same general location. In other embodiments, Fog 140-155 are linked to agent 120-130 through network connections between geographically distributed systems, including network connection over the Internet. Fog 140-155 generally includes a central processing unit (CPU) connected by a bus to memory (not shown) and storage. Fog 140-155 may incorporate one or more general-purpose processors and/or one or more special-purpose processors (e.g., image processor, digital signal processor, vector processor, etc.). To the extent that fog 140-155 includes more than one processor, such processors could work separately or in combination. Fog 140-155 may be configured to control functions of system 100 based on input received from one or more devices or agents 120-130, or different clients via a user interface, for example.

Each fog 140-155 is typically running an operating system (OS) configured to manage interaction between the computing device and the higher level software running on a user interface device as known to an artisan of ordinary skill in the art.

The memory of fog 140-155 may comprise one or more volatile and/or nonvolatile storage components such as optical, magnetic, and/or organic storage and fog memory may be integrated in whole or in part with computing fog 140-155. Fog 140-155 memory may contain instructions e.g., applications programming interface, configuration data) executed by the processor in performing various functions of fog 140-155, including any of the functions or methods described herein. Memory may further include instructions executable by fog 140-155 processor to control and/or communicate with other devices on the network. Although depicted and described with respect to an embodiment in which each of the APIs, engines, databases, and tools is stored within memory, it will be appreciated by those skilled in the art that the APIs, engines, database, and/or tools may be stored in one or more other storage devices external to fog 140-155.

Peripherals may include a speaker, microphone, and screen, which may comprise one or more devices used for displaying information. The screen may comprise a touchscreen to input commands to fog 140-155. As such, a touchscreen may be configured to sense at least one of a position in the movement of a user's finger via capacitive sensing or a surface acoustic wave process among other possibilities. Generally, a touchscreen may be capable of sensing finger movement in a direction parallel or perpendicular to the touchscreen surface of both, and may also be capable of sensing a level of pressure applied to the touchscreen surface. A touchscreen comes in different shapes and forms.

Fog 140-155 may include one or more elements in addition to or instead of those shown. In one embodiment, Fog 140-155 communicate with device or agent 120-130 via wired network (such as USB, Ethernet. In other embodiments, Fog 140-155 communicate with device or agent 120-130 via wireless network (such as Bluetooth, WiFi®). Generally, data communication between agent 120-130 and fog 140-155 is TCP/IP based.

Fogs 140-155 are associated with (Data Base) DB 141, 146 and 156 respectively. DB 141, 146 and 156 store data generated and used by fog 140-155. DB 141, 146 and 156 are used to store data designated as Whitelist data, Blacklist data, Agent Whitelist, Agent Blacklist. Agent Whitelist data includes whitelist data applied in agent's processing. Blacklist data refers to a list of denied entities, ostracized or unrecognized for access to cloud 170 or fog 140-155 resources.

Router 135 forwards data packets from device or agent 120-130 to fog 140-155 and vice versa. In one embodiment, router 135 is a separate device, which connects agent 120-130 to fog-140-155 network. In other embodiments, router 135 is software based and resides on fog 140-155. Similarly, router 160 forwards data packets from fog 140-155 to cloud 170 and vice versa. In one embodiment, router 160 is a separate device, which connects fog-140-155 network to cloud 170 networks. In other embodiments, router 160 is software based and resides on fog 140-155. In some embodiments cloud 170 and fog 140-155 communicate using wired network such as Ethernet. In other embodiments, cloud 170 and fog 140-155 communicate using wireless network such as WiFi®.

Cloud 170 is an information technology (IT) paradigm, a model for enabling ubiquitous access to shared pools of configurable resources (such as fog networks, servers, storage, applications and services), which can be rapidly provisioned with minimal management effort, often over the Internet. In simple terms, cloud computing is the delivery of fog computing services-servers, storage, databases (whitelist, black list) networking, software, analytics, and more-over the Internet. In one embodiment, cloud 170 is public. In other embodiments, cloud 170 is private. In yet other embodiments, cloud 170 is a hybrid cloud.

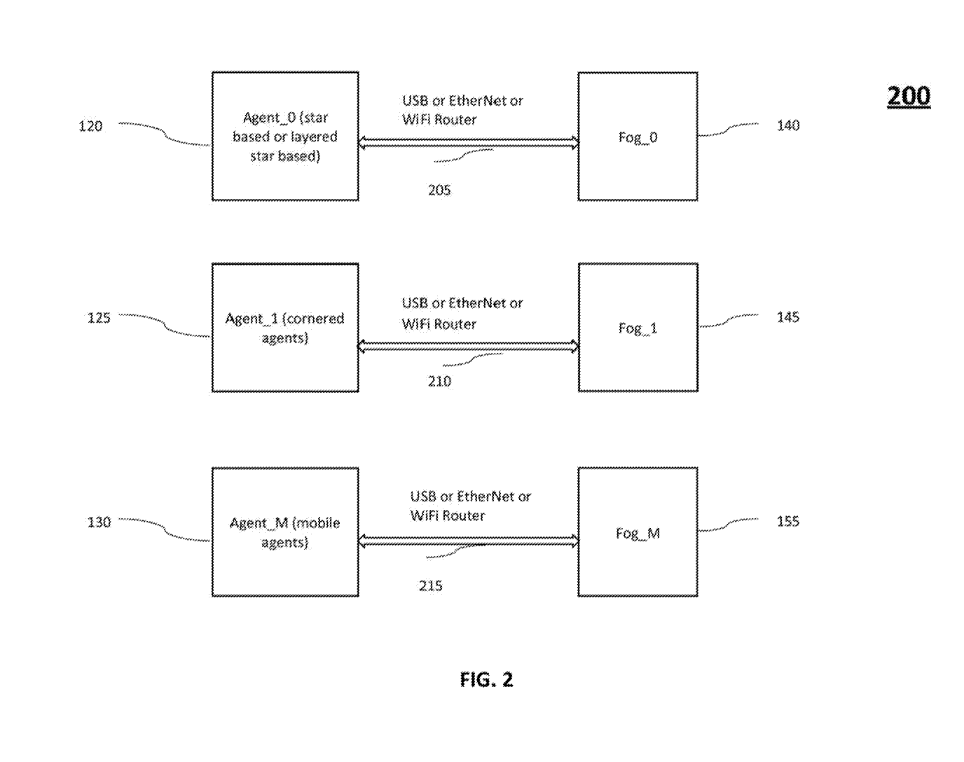

FIG. 2 depicts a high-level block diagram of an implementation according to the system of FIG. 1. Specifically, FIG. 2 depicts an embodiment arranged on a point-to-point configuration. As shown, device or agent 120 is connected to fog 140 via connection 205; device or agent 125 is connected to fog 145 via connection 210 and device or agent 130 is connected to fog 155 via connection 215. This point-to-point topology allows communication using USB cable, Ethernet or WiFi®.

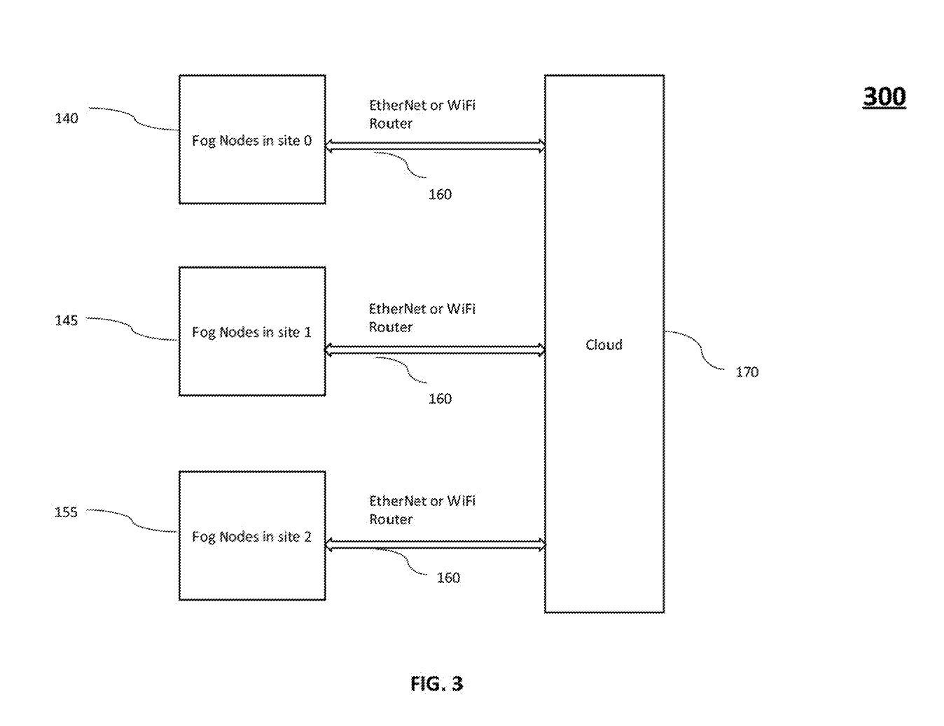

FIG. 3 depicts a high-level block diagram of an implementation according to the system of FIG. 1. Specifically, FIG. 3 depicts an embodiment arranged on a point-to-point configuration. As shown, fog 140 is connected to cloud 170 via connection 305; fog 145 is connected to cloud 170 via connection 310 and fog 155 is connected to cloud 170 via connection 315. This point-to-point topology allows communication using USB cable, Ethernet or WiFi®. In this embodiment, cloud 170 is a private cloud. In another embodiment, cloud 170 is a hybrid cloud. As indicated, one site may contain more than one fog networked and communicating to cloud 170 via a router. Cloud 170 is subdivided into a private cloud allowing point-to-point communication whereas the public portion is configured to allow more than one fogs to share the communication path.

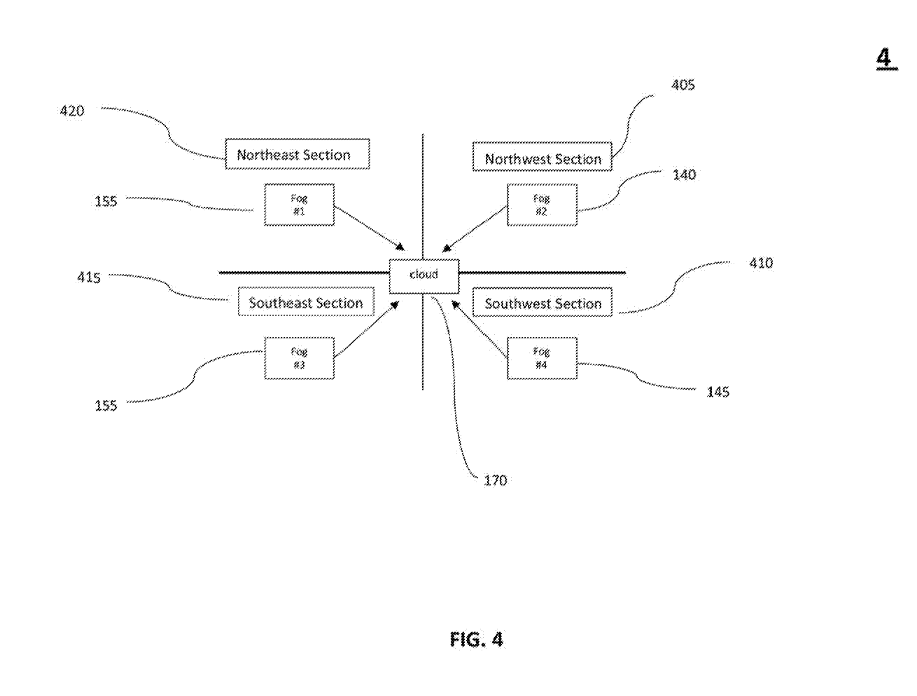

FIG. 4 depicts a network of fogs from different locations linked together to the cloud. Whitelist management process as explained supra can be extended to track various items or Whitelist data in various physical and geographical locations. For instance, it could be in different buildings, different neighborhoods or different cities or countries. Each specific location 405-420 would have its own fog nodes 140-155 but individual fogs and all are linked together to a remote cloud 170 in one embodiment or local cloud 170 in another embodiment, therefore enabling tracking of Whitelist items across individual fog networks.

This extension of whitelist management is important. Hospitals or other healthcare institutions are no longer one building but comprised of a network of buildings in multiple locations. This expands the capabilities of tracking Whitelist data as it moves from location to location.

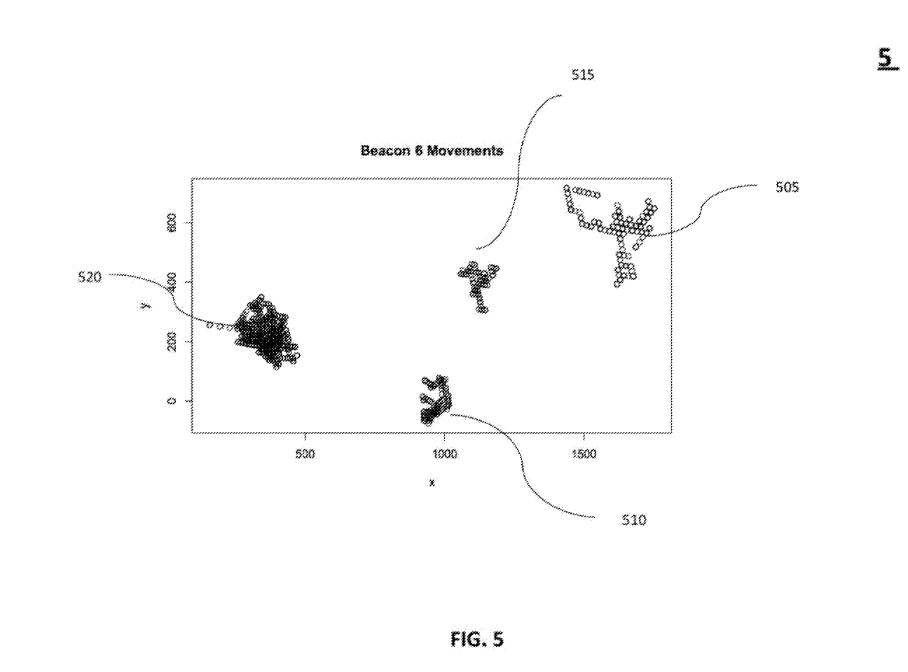

FIG. 5 depicts an exemplary Movement Factor implementation according to the system of FIG. 1. Due to the general nature of the equipment, beacons standing still in a single location are detected by agents and read by the router as sporadic movements within a small radius around a center point as illustrated in FIG. 5. As shown in FIG. 5, the data collected by the movement of the beacon shows the beacon standing still in four different locations 505-520 in a single room.

In order to accurately analyze the exact location from the varying data points collected by the Beacon Signal Measurer from a beacon standing still in a single location, a small radius can be statistically determined around a statistically determined center point. This radius will be deemed the Movement Factor. All the points lying within the Movement Factor will be defined as non-mobile at the center point.

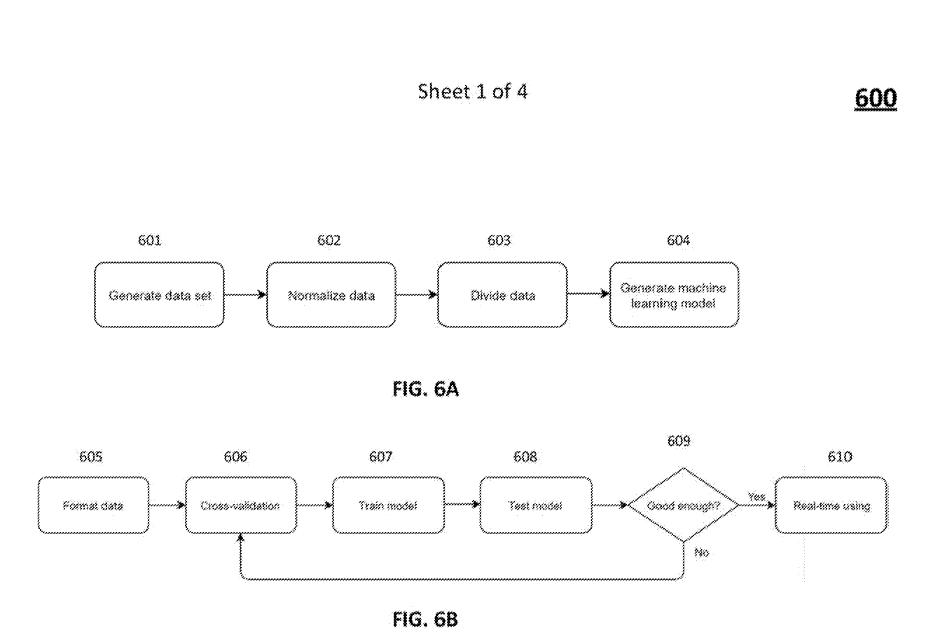

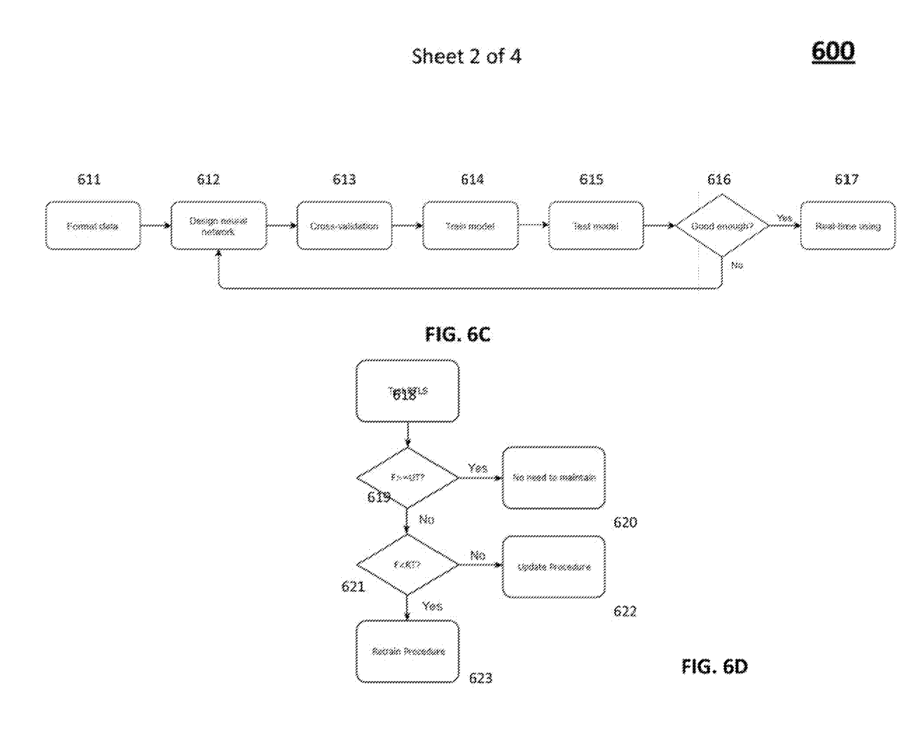

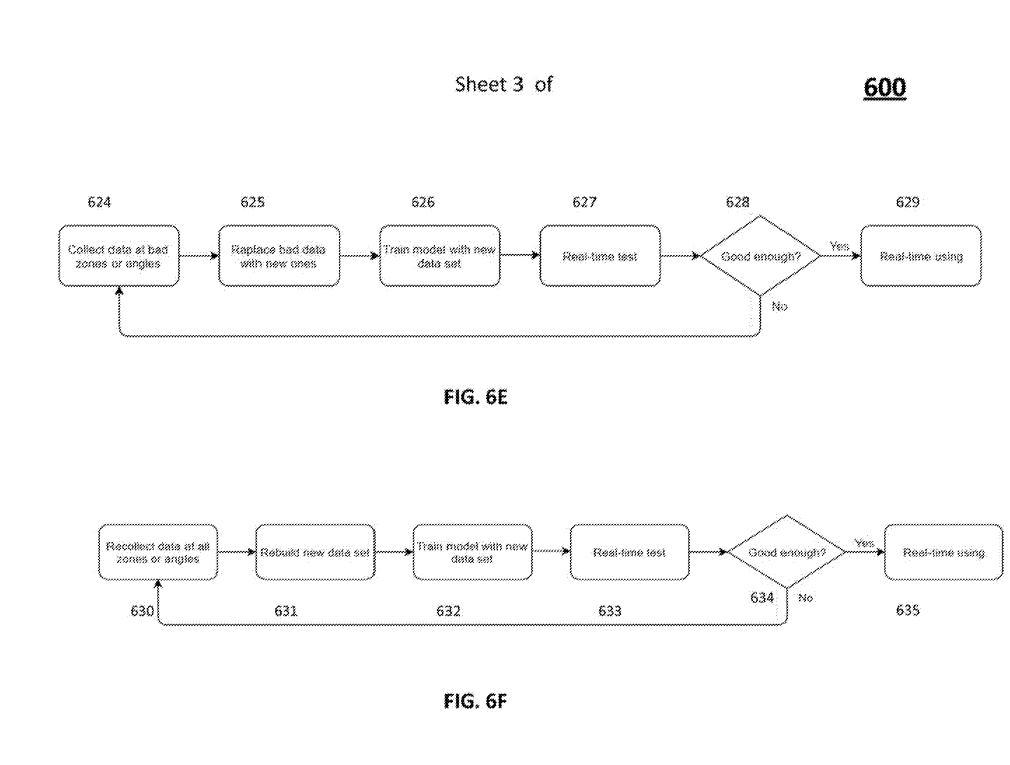

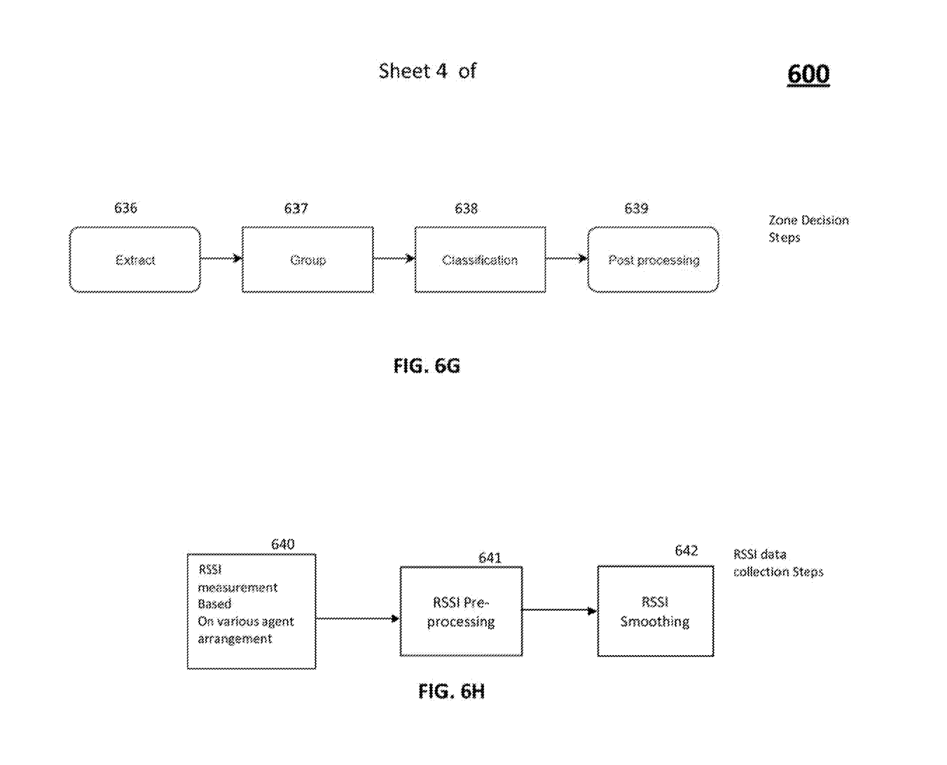

The processes and procedures to determine for a particular environment, the optimal placement of one or more agents to thereby map the spatial coordinates of the particular environment and correlate the location of the one or more agents associated with the particular environment are described below in relation to FIGS. 6A-6H.

FIG. 6A depicts a Flow Chart of a process for implementing the Training Model Optimization algorithm according to an embodiment of the invention. In general, there are four steps for training model and optimization. At step 601, the data set is generated. We build data set from all eight (8) agents log file. Log file includes mac address, RSSI and time. There are two requirements. First, all eight (8) or four (4) RSSI must be at the same time, which means time difference must be no more than 0.5 second. Second, one (1) set of data must have eight (8) or four (4) RSSI for features, and the known location in certain angle (or zone) for label. At step 602, the data is normalized. Different features range will have negative impact on machine learning, the data is normalized. Normalization is achieved by the following two ways:

1. Min-Max Scaling:
Mapping each value into [0,1]

$${X}_{norm} = \frac{X - {X}_{m i n}}{{X}_{m ax} - {X}_{m i n}}$$

2. Z-score Standardization:

$${X}_{norm} = \frac{x - μ}{σ}$$

At step 603, the data is divided. The operation is to divide all the data set into three parts: training set, testing set and cross-validation set. In one embodiment, the proportion is like training set:testing set:cross-validation=0.5:0.25:0.25. In other embodiments, other proportions are applied.

In step 604, the training model is generated as explained below in reference to FIG. 6B.

### Machine Learning Based RTLS

Machine Learning Based RTLS has three kinds of agent placement and zone division.
Star based (8 agents)
Layered Star based (4+4 agents)
Corner based

Machine Learning Based RTLS utilizes three approaches of machine learning including:
Support Vector Machine(SVM)
Artificial Neural Network(ANN)
k-Nearest Neighbors(k-NN).

Machine Learning Based RTLS includes the following three procedures:
Data collection
Model training
Real-time classification

### Agent Placement and Zone Decomposition

We will describe agent placement and zone decomposition for three configurations.
Star based
Layer star based
Corner based

FIG. 6B depicts a Flow Chart of a process for implementing the Generate Training Model (Support Vector Machine (SVM)) algorithm according to an embodiment of the invention. At step 605, the data is transformed to the format, which the SVM tool needs. At step 606, the best parameters are found using cross-validation set. At step 607, known parameters are used to train the model. At step 608, the model is tested. At step 609, a decision is made whether or not the model is good enough. If no, step 606 is repeated. If yes, step 610 is executed and the model is used in real-time.

FIG. 6C depicts a Flow Chart of a process for implementing the Generate Training Model (Artificial Neural Network (ANN)) algorithm according to an embodiment of the invention. At step 611, the data is transformed to the format, which the ANN tool needs. At step 612, the topology of the neural network is designed. At step 613, an activation function is chosen for cross validation. At step 614, the model is trained using a training set. At step 615, the model and parameters are tested using the testing set. At step 616, a decision is made whether or not the model is good enough. If no, step 612 is repeated. If yes, step 617 is executed and the model is used in real-time.

For k-NN:

Rather than taking only the closest matching fingerprint for getting the target position several points can be used. The impact of noise is reduced by using several points as the risk of having measurements failing in one position is mitigated by having several positions. The simplest version of KNN fingerprinting is to estimate the target point to be the average of the K closest points. The algorithm can be further improved on this by calculating a weighted average based on how close the fingerprint match is for each of the K nearest neighbors. A good value for K has to be decided experimentally but it is often chosen to be approximately in order of the square root of the number of data points.
1. Compute the distance d between each new measurement and all known measurements in the training dataset.
2. Select the k neighbors within the training dataset with the smallest distances.
3. Compute a weighted average of all known measurements in training dataset corresponding to the k-nearest neighbors
4. Repeat the previous three steps for all unseen measurements

FIG. 6D depicts a Flow Chart of a process for implementing the Training Model Calibration algorithm according to an embodiment of the invention. The Calibration function depends on F-measure, which is derived from accuracy, precision and recall. For calibration on zone decision, we make the following definitions:
True positive(TP): Target is in the zone and the model predicts it is in the zone.
False negative(FN): Target is in the zone but the model predicts it isn't in the zone.
False positive(FP): Target isn't in the zone but the model predicts it is in the zone.
True negative(TN): Target isn't in the zone and the model does not predict it is in the zone.

$$Accuracy = \frac{TP + TN}{TP + TN + FN + FP}$$

$$Precision = \frac{TP}{TP + FP}$$

$$Recall = \frac{TP}{TP + FN}$$

F-measure:

$$F = 2 \cdot \frac{Precision \cdot Recall}{Precision + recall}$$

Referring now to FIG. 6D, at step 618 the Real-Time Locating System (RLTS) is tested. At step 619, a decision is made whether or not “F” is greater or equal to “UT.” If yes, step 620 is executed. If no, step 621 is executed where another decision is made whether or not “F” is greater or equal to “RT.” If no, step 622 is executed where the procedure is updated. If yes, step 623 is executed where the procedure is retained.

FIG. 6E depicts a Flow Chart of a process for Updating the procedure in implementing the Training Model Calibration algorithm according to an embodiment of the invention. At step 624, data collection is done over in the zone that has a low F score. At step 625, bad data is replaced with new ones. At step 626, the model is trained with new data set. At step 627, the real time test is repeated. At step 628, a decision is made as to whether or not the new model is good enough. If no, step 624 is repeated. If yes, step 629 is executed where the model is used in real-time.

FIG. 6F depicts a Flow Chart of a process for the retrain procedure in implementing the Training Model Calibration algorithm according to an embodiment of the invention. At step 630, data at zones and angles are recollected. At step 631, a new data set is rebuilt. At step 632, the model is trained with the new data set. At step 633, the model is tested in real-time. At step 634, a decision is made as to whether or not the new model is good enough. If no, step 630 is repeated. If yes, step 635 is executed where the model is used in real-time.

### Room Decision Functions/Zone Decision Functions

FIG. 6G depicts a Flow Chart of a process for real-time room/zone decision in implementing the Training Model Calibration algorithm according to an embodiment of the invention.

Average of RSSI in one room: When the average of RSSI measurement of one room is calculated, the beacon is estimated to be located in the room with the strongest average RSSI measurement.

The following steps are performed. At step 636, Extract all RSSI from real-time measurements.
All RSSI should be collected at the same time.
If we filter the data to feed into train model, we must apply the same filter as well
The measurement will include beacon's transmission power at one (1) meter, say “A0.” If “A0” does not match the beacon's transmit power at one (1) meter, say “A1,” used in building the model, we will adjust the measured RSSI to adapt our trained model by offsetting the RSSI with the difference between “A0” and “A1.”

At step 637, Group all RSSI together in the certain format for SVM, ANN and k-NN respectively. At step 638, perform classification with trained model to generate result of angle or zone. At step 639, post processing: Even after applying filters, RSSI usually have huge fluctuation, so we have post processing to further avoid fluctuation of identified zone results.
If all the RSSI are bigger than a certain threshold, we will consider the beacon is in the center zone.
We get list of classification in 1-5 seconds, then calculate the frequency of different classification.
Then we could determine the high probability and low probability angle or zone. For 4+4 approach, we will get two (2) angle or zone from two (2) models, we should combine them and finally get “1” high probability and “2” low probability angle or zone.

FIG. 6H depicts a Flow Chart of a process for Received Signal Strength Indication (RSSI) data collection in implementing the algorithm according to an embodiment of the invention. At step 640, RSSI measurement is performed based on various agent arrangement. During the data collection, we will apply adaptive filter to smoothen the RSSI, which could avoid RSSI radical change. At step 641, RSSI pre-processing is performed. Due to wireless signal fluctuation and fading, two steps are needed:
Pre-processing: The measurement will include beacon's transmission power at one (1) meter, say “A0.” If “A0” does not match the beacon's transmit power at one (1) meter, say “A1,” used in building the model, we will adjust the measured RSSI to adapt our trained model by offsetting the RSSI with the difference between “A0” and “A1.”

At step 642, RSSI smoothing is performed based on Karman filter or average value filter. Below are examples of performance of zone decision functions.

1. Star based:

| | Accuracy | Precision | | |
|---|---|---|---|---|
| | (%) | (%) | Recall (%) | F-score |
| 22.5° | 100 | 100 | 100 | 1.0 |
| 67.5° | 100 | 100 | 100 | 1.0 |
| 112.5° | 100 | 100 | 100 | 1.0 |
| 157.5° | 100 | 100 | 100 | 1.0 |
| 202.5° | 100 | 100 | 100 | 1.0 |
| 247.5° | 99.90 | 99.88 | 100 | 0.999 |
| 292.5° | 99.90 | 100 | 99.09 | 0.997 |
| 337.5° | 100 | 100 | 100 | 1.0 |

Overall accuracy: 99.90%
2. Layer star based:

### Model 1

| | Accuracy | Precision | | |
|---|---|---|---|---|
| | (%) | (%) | Recall (%) | F-score |
| 45° | 99.92 | 100 | 100 | 1 |
| 135° | 99.92 | 99.66 | 100 | 0.9983 |
| 225° | 99.92 | 100 | 99.68 | 0.9984 |
| 315° | 100 | 100 | 100 | 1 |

Overall accuracy: 99.92%

### Model 2

| | Accuracy | Precision | | |
|---|---|---|---|---|
| | (%) | (%) | Recall (%) | F-score |
| 0° | 99.66764 | 99.68504 | 99.06103 | 0.993721 |
| 90° | 99.086 | 97.96954 | 98.30221 | 0.981356 |
| 180° | 99.62609 | 99.45946 | 98.92473 | 0.991914 |
| 270° | 99.62609 | 99.45946 | 98.92473 | 0.970329 |

Overall accuracy: 98.17%
3. Corner based:

| | Accuracy | Precision | | |
|---|---|---|---|---|
| | (%) | (%) | Recall (%) | F-score |
| Zone 1 | 98.29116 | 96.90141 | 95.82173 | 0.963585 |
| Zone 2 | 98.12685 | 94.91833 | 94.74638 | 0.948323 |
| Zone 3 | 98.91554 | 95.70815 | 97.16776 | 0.964324 |
| Zone 4 | 99.50707 | 99.02439 | 97.36211 | 0.981862 |
| Zone 5 | 99.3756 | 98.4547 | 99.4426 | 0.989462 |

Overall accuracy: 98.84%

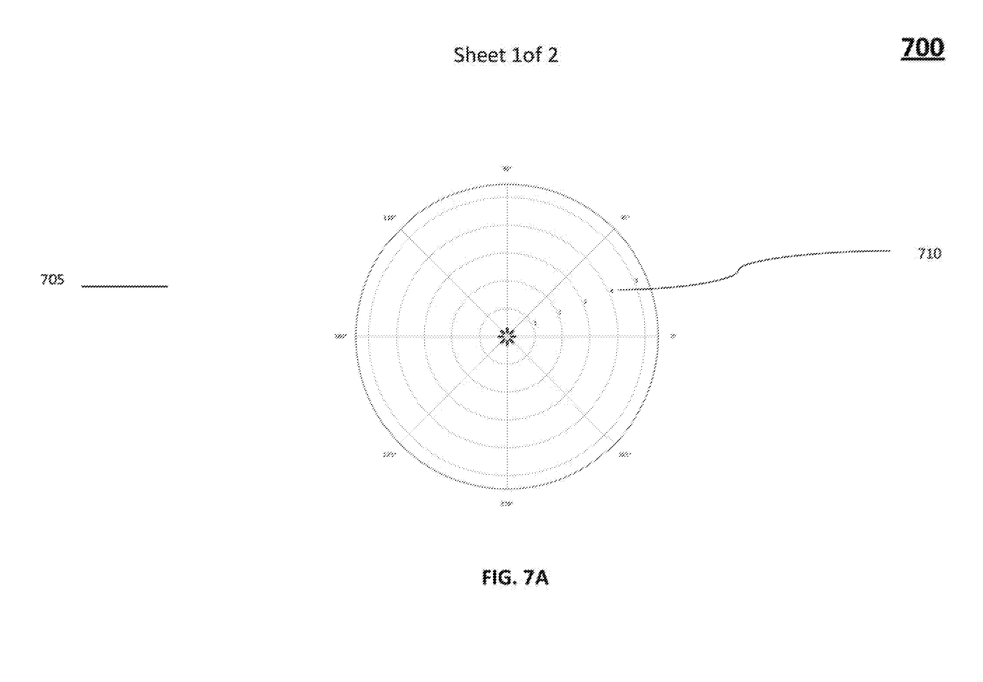

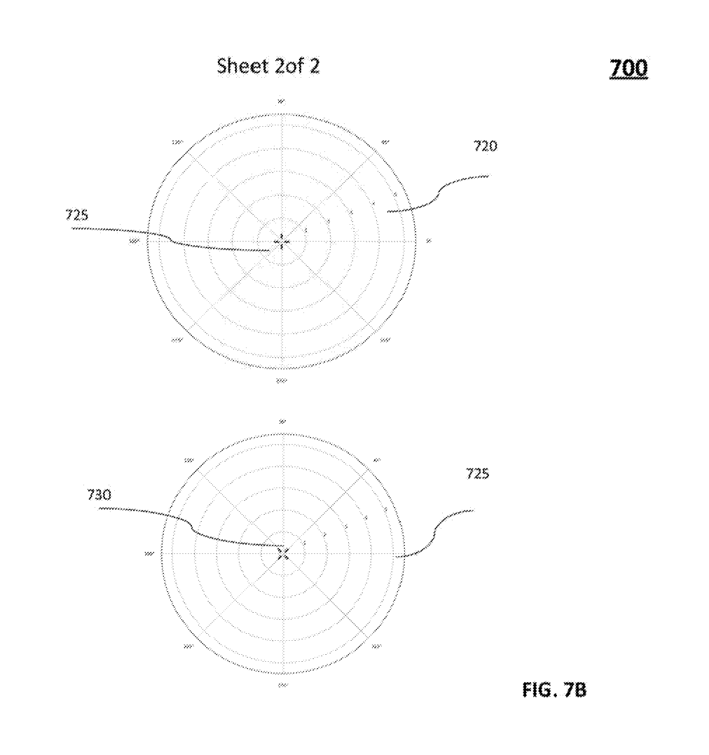

FIG. 7A depicts a Star Based Arrangement of an implementation according to the system of FIG. 1. Using eight (8) agents 705 with omni antenna and divide a round area into “8+1” zones 710 based on angle and radius, which means each zone is a part of ring with 45 degrees. This is considered to be similar to RSSI in the area which are close to our antenna (which means beacon is no more than 1 m away from agents), we define a center round zone with approximate 1 m radius.

FIG. 7B depicts a Layer Star Based Arrangement of an implementation according to the system of FIG. 1. Using “4+4” agents with omni antenna and divide a round area into “4+4+1” zones 720 based on angle and radius. First, we use four (4) agents 715 and divide round area into four (4) zones, which means each zone is a part of ring with ninety (90) degrees. Second, we use four (4) rotated agents 730 and divide round area 725 into four (4) rotated zones as shown in FIG. 7B. These two ways of zone division will help each other to improve the accuracy when the beacon is around borderline. At last we define a center round zone with approximate one (1)m radius.

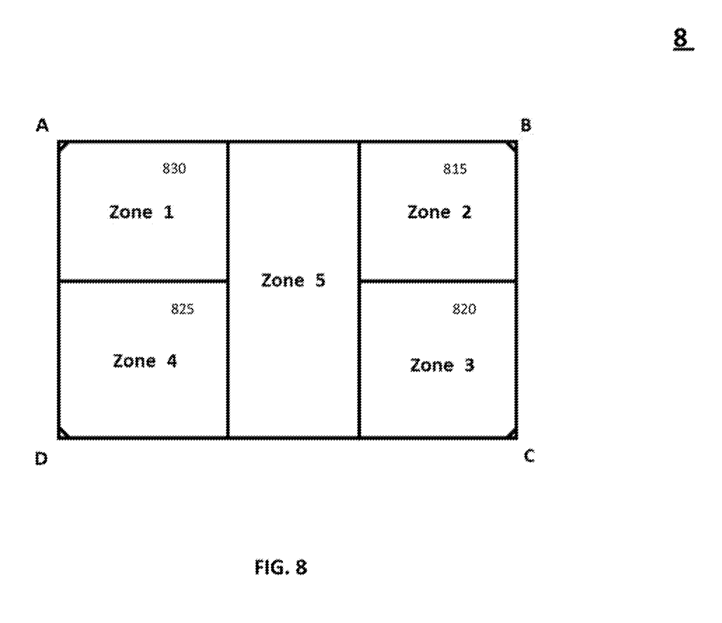

FIG. 8 depicts a Corner Based Arrangement of an implementation according to the system of FIG. 1. As shown, four (4) agents will be placed in four (4) corners namely, 815, 820, 825 and 830.

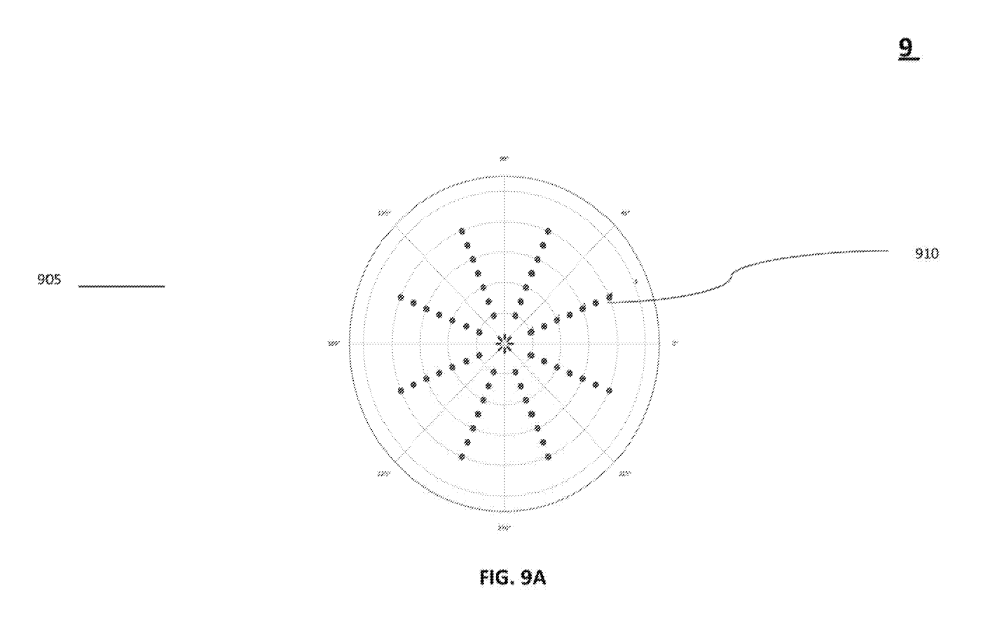

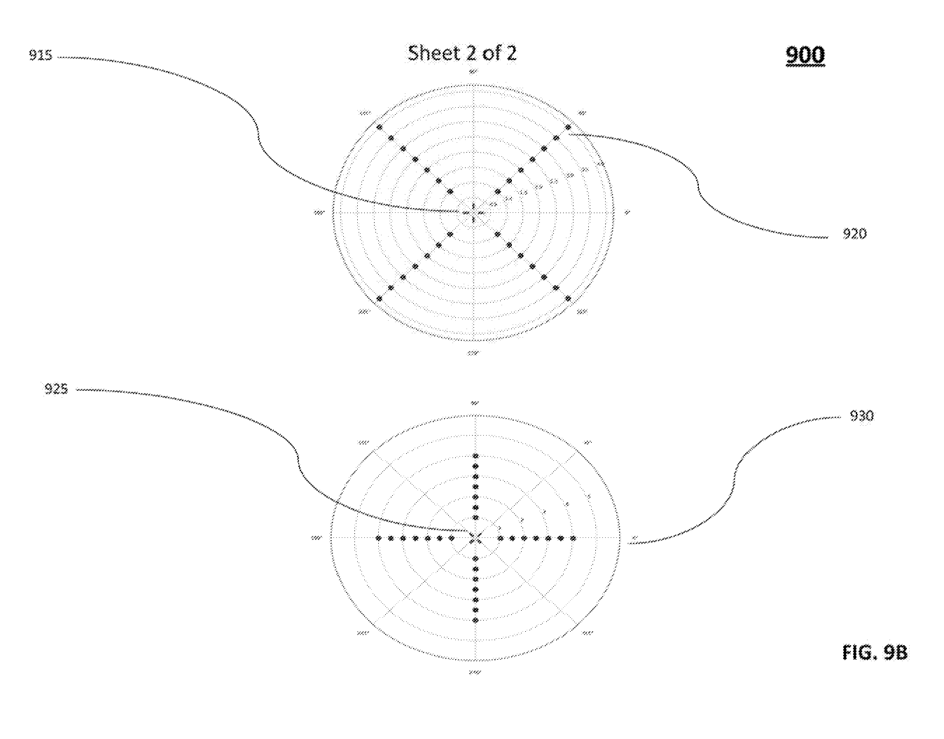

FIG. 9A depicts a Star Based Arrangement of an implementation according to the system of FIG. 1. RSSI data is collected from all eight (8) agents at every point for more than twenty (20) minutes. Those points are located at eight (8) lines, which are 22.5, 67.5, 112.5, 157.5, 202.5, 247.5, 292.5, 337.5 degree. The distance between every two points in the same line is 0.5 m. Agents 905 and points 910 are placed as shown in FIG. 9A. We will measure one or multiple beacons to collect RSSI data. RSSI from eight (8) agents will be the eight (8) features for model 1 training.

FIG. 9B depicts a Layer Star Based Arrangement of an implementation according to the system of FIG. 1. RSSI data is collected from all four (4) agents at every point for more than twenty (20) minutes. The distance between every two points in the same line is 0.5 m. Agents 915, 925 and points 920, 930 are placed as shown in FIG. 9A. We will measure one or multiple beacons to collect RSSI data. RSSI from four (4) agents will be the four (4) features for model 2 training. The models from these two layers are then combined to build trained machine learning model.

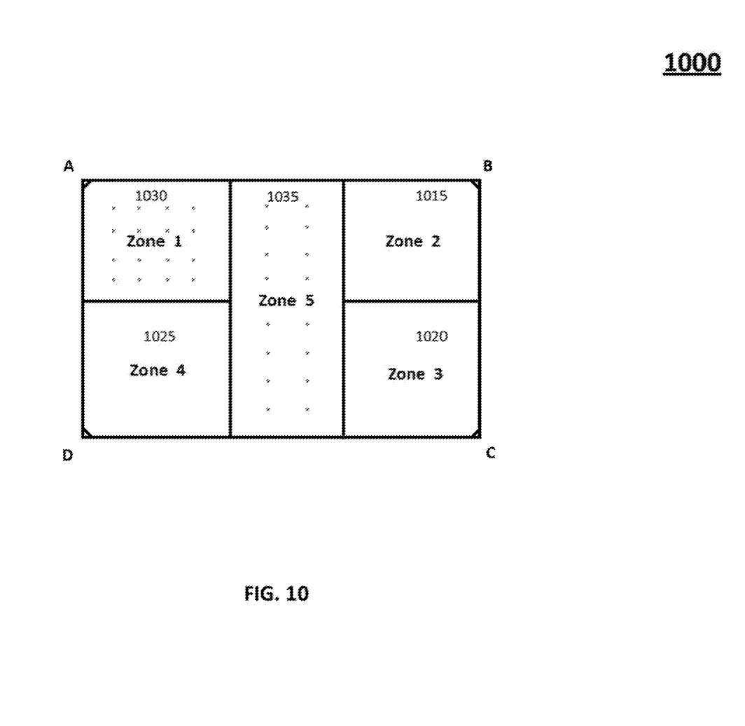

FIG. 10 depicts Data Collection for Corner Based Arrangement of an implementation according to the system of FIG. 1. To collect data in zone 1015, 1020, 1025, 1030 and 1035, data is collected at positions of 4*4 points (illustrated as 1030 and 1035) in evenly distributed in each rectangular zone for 20-30 minutes.

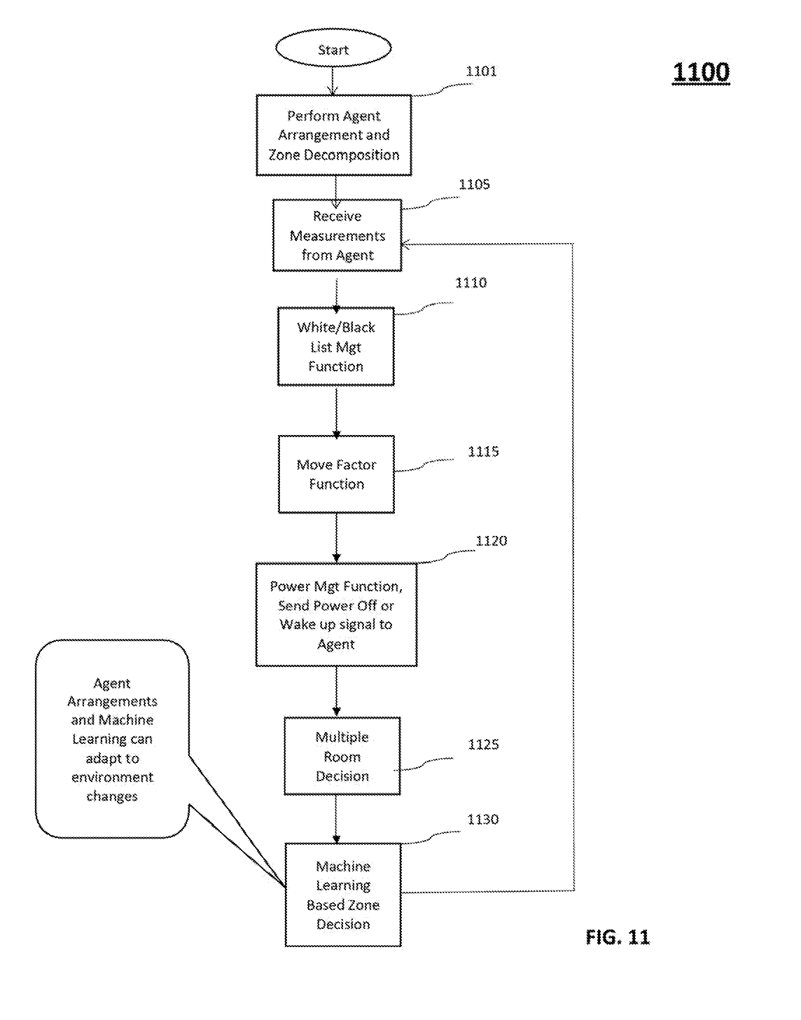

FIG. 11 depicts a Flow Chart of a process for determining real-time data in implementing the algorithm according to an embodiment of the invention.

Various embodiments operate to provide a flexible tool that can be tuned to achieve the above outlined objectives without sacrificing others.

At step 1101, the optimal placement of one or more agents is determined for a particular environment to thereby map the spatial coordinates of the particular environment and correlate the location of the one or more agents associated with the particular environment. Training Model Calibration algorithm is working in the background calibrating parameters for machine learning model to be used in current placement of agents and determine if a new agent placement is needed to optimize performance. At step 1105, the receive measurement from agents routine is executed. Specifically, the signal measurement count is initialized. For example, the following commands are executed: (1) “Initialize signal_measurement_count=in beacon address scanner; (2) Initialize address scanning count: Initialize address_scanning_count=0 in beacon signal measurer; the following steps are repeated: (3) Update signal measurement count and address scanning count: Beacon address scanner continues to scan beacon addresses for any signals that can be observed in the agent, and extract beacon addresses scanned:
i) If the observed address is in the Fog Whitelist (query the fog Whitelist from agent), then reset signal_measurement_count=0, and wake up Beacon signal measurer.
ii) If the observed address is in the Fog Blacklist (query the fog Blacklist from agent), then increase signal_measurement_count by 1
iii) If the observed address is not in the Fog Whitelist or Blacklist, then increase signal_measurement_count by 1
iv) If no beacon is detected, then increase address scanning count by “1.”
v) Power Off Mode: If signal_measurement_count=signal_measurement_timeout then power off Beacon Signal Measurer.
vi) Sleep Mode: If address_scanning_count=address_scanning_timeout then put Beacon Address Scanner in sleep mode. Beacon Address Scanner will wake up after predefined timeout period.

At step 1110, the white/black list management function is executed. For example, the following commands are executed.

1) Initialize Fog Whitelist: Input of beacon addresses that are intended to be monitored into Fog Whitelist
2) Initialize Fog Blacklist: Initialize null in Fog Blacklist

Repeat periodically the following steps 3-6:

3) Update Fog Whitelist and Blacklist: Beacon address scanner continue to scan beacon addresses for any signals that can be observed in the agent, and extract beacon addresses scanned:
i) If the observed address is in the Fog Whitelist (query the fog Whitelist from agent), then add the address to the Agent Whitelist
ii) If the observed address is in the Fog Blacklist (query the fog Blacklist from agent), then add the address to the Agent Blacklist
iii) If the observed address is not in the Fog Whitelist or Blacklist, then add the address to the Agent Blacklist.
   4) Synchronize Beacon signal measurer: Update Agent Whitelist information to the Beacon signal measurer. Beacon signal measurer is in general a hardware/ASIC circuit that can only measure limited number of beacons signal samples within a specified interval.
   5) Emit Beacon Signals: Beacon signal measurer periodically measures and sends out beacon signal strength for only those beacons in Agent Whitelist to the fog node.
   6) Synchronize Fog Blacklist: Update the Agent Blacklist addresses to Fog Blacklist based on security policy of operating environment. At step 1115, the move factor function is executed. The Move Factor function was described above in reference to FIG. 5 and need not be repeated here. At step 1120, the power management function is executed. Power management includes power off Beacon Signal Measurer and Beacon Address Scanner during system operations. The main idea is to power off Beacon Signal Measurer when no observed beacon is in Fog Whitelist for certain period of time (signal measurement timeout). Put Beacon Address Scanner into sleep mode when no beacon is observed for certain period of time (address scanning timeout). At step 1125, the multiple room decision function is executed. This function is specifically described in reference to FIGS. 7A-7B, 8 and 9A-9B. At step 1130, machine learning zone based decision is performed. The process loops back to step 1105. Although primarily depicted and described herein with respect to the embodiments described herein, it will be appreciated that the algorithm may be modified and used in other embodiments.

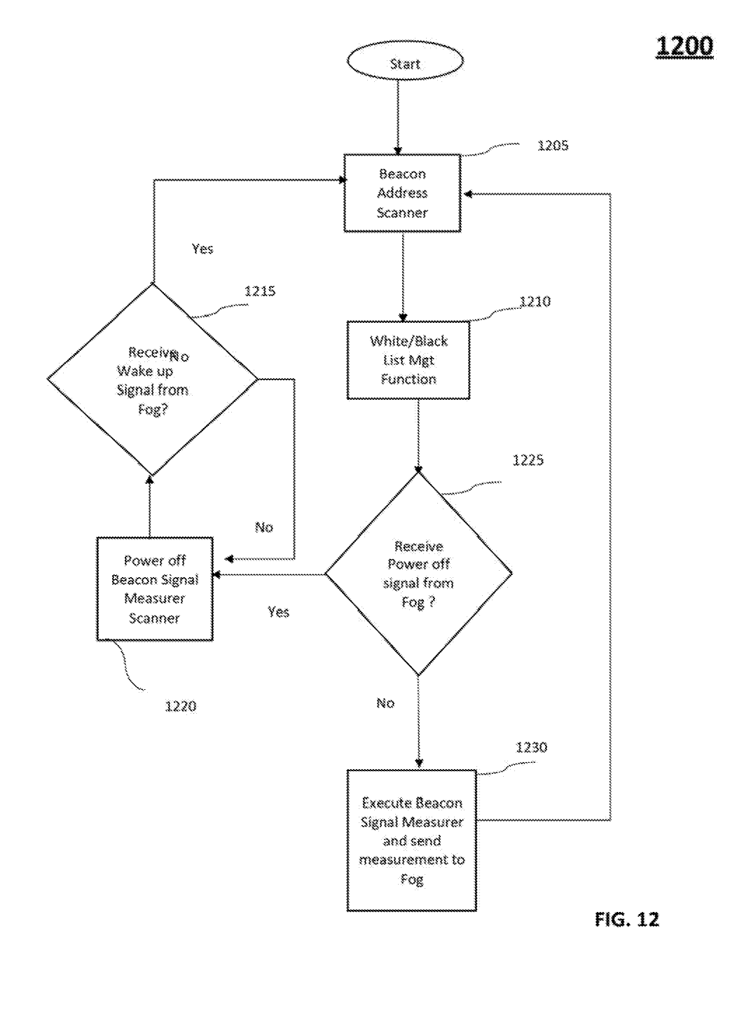

FIG. 12 depicts a Flow Chart of a process for acquiring data in implementing the algorithm according to an embodiment of the invention. At step 1205, the beacon address scanner function (which detects Identification code such as Bluetooth, MAC address or UUID code) is executed. Moving Beacon transmitters transmit constant wireless signals to the fixed Beacon Receivers whose locations are known. This constant wireless signals from moving Beacons to the Agents (Beacon Receivers) provide raw data information such as Identification code, Radio Signal Strength, etc. By combining the Radio Signal Strength and the known Agent locations, and using algorithms such as triangulation, the location of the moving Bluetooth Beacon is calculated. At step 1210, the white/black list management function is executed. The agent receives the data from the fog and compiles the white/black list accordingly. At step 1225, if the power off signal is received from the fog, then step then step 1220 is executed. If not, then step 1225 is executed. At step 1230, the beacon signal measurer function (which accumulates wireless signal samples to calculate Radio Signal Strength, such as RSSI) is executed and the measurements obtained are sent to the fog. At step 1220, power is turned off to the beacon signal measurer. At step 1215, if the wake-up signal has not been received, power remains turned off. If the wake-up signal is received, step 1205 is executed. Although primarily depicted and described herein with respect to the embodiments described herein, it will be appreciated that the algorithm may be modified and used in other embodiments.

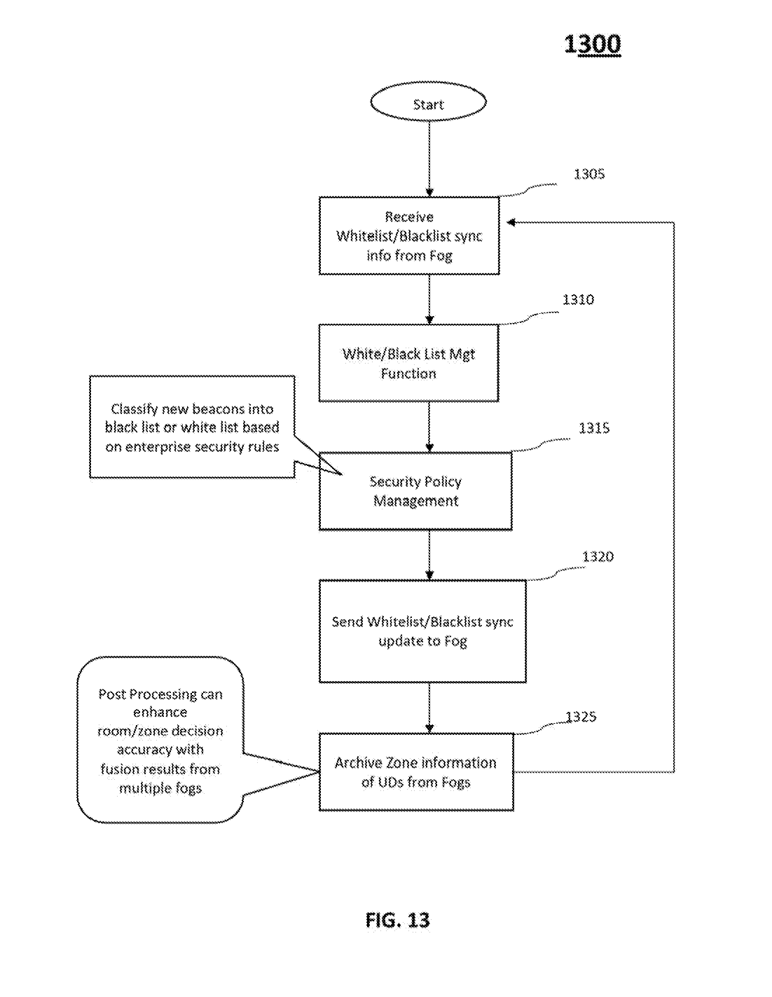

FIG. 13 depicts a Flow Chart of a process for characterizing real-time data in implementing the algorithm according to an embodiment of the invention. At step 1305, the white/black list sync data is received from a fog. At step 1310, the white/black list management function is executed. For example, these commands are executed:
1. Initialize Fog whitelist: Fog whitelist Initializes beacon addresses that are intended to be monitored in Cloud Whitelist
2. Initialize Fog blacklist: Fog Blacklist Initializes null in Cloud Blacklist
3. Maintain lists based on Beacon security policy: Beacon security policy continues to monitor changes in Cloud Whitelist, Cloud blacklist, and Fog blacklist:
a) If changes in the Cloud Whitelist (query the Cloud Whitelist from Fog), then synchronize address changes to the Fog Whitelist
b) If changes in the Cloud Blacklist (query the Cloud Blacklist from Fog), then synchronize address changes to the Fog Blacklist
c) If changes in the Fog Blacklist, then synchronize address changes to the Cloud Blacklist.

At step 1315, the security policy management function is executed. The management of security policy can be based on a predefined cloud whitelist which is maintained in a database table residing in the cloud. This table stores all beacon IDs for whitelist, and can be maintained by security staff. Additional rules for security practice are varied from organizations to organizations. For instance, these additional rules can be implemented in the cloud whitelist database to move whitelist beacon ID to blacklist beacon when certain security violation is triggered. Furthermore, security events triggering rules can be defined to associate with the database. At step 1320, the white/black list sync update data is forwarded to the fog. At step 1325, the UD zone information received from the fog is archived. Although primarily depicted and described herein with respect to the embodiments described herein, it will be appreciated that the algorithm may be modified and used in other embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, and the like. Furthermore, it has also proven convenient at times, to refer to these arrangements of operations as modules. The described operations and their associated modules may be embodied in software, firmware, hardware, or any combinations thereof.

Any of the steps, operations, or processes described

herein may be performed or implemented with one or more hardware or software modules, alone or in combination with other devices. In one embodiment, a software module is implemented with a computer program product comprising a computer readable medium containing computer program code,
which can be executed by a computer processor for performing any or all of the steps, operations, or processes described.

Embodiments of the invention may also relate to a product that is produced by a computing process described

herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore, intended that the scope of the invention be limited not by

this detailed description, but rather by any claims that issue on an application based hereon.

Although various embodiments, which incorporate the teachings of the present invention, have been shown and described in detail herein, those skilled in the art can

readily devise many other varied embodiments that still incorporate these teachings.

1. A system for determining real-time spatial coordinates of a user device (UD), the system comprising:
a computing architecture having one or more agents optimally located in an area of an environment to thereby map the spatial coordinates of the particular environment and correlate the location of the one or more agents associated with the particular environment, said one or more agents communicatively coupled to a first routing device;
one or more fogs communicatively coupled to the first routing device and
configured with a non-transitory computer readable medium having stored thereon instructions that, upon execution by a central processing engine, cause the central processing engine to execute one or more applications associated with the one or more fogs to determine real-time spatial coordinates of a user device, thereby enabling said one or more fogs to:
(a) process characterization data associated with one or more user devices to
thereby perform data mining of the one or more user devices and assign at least a tag to each of the one or more user devices;
(b) transmit one or more commands towards the one or more agents;
(c) receive from the one or more agents data associated with a specific user device;
(d) normalize the data of the specific user device to thereby determine the real-time spatial coordinates based on the corresponding data associated with said user device; and
(e) transmit one or more commands towards a cloud server communicatively
coupled to the fog via a second routing device.

2. The system of claim 1, wherein the user device comprises a wireless digital transceiver.

3. The system of claim 1, wherein the fog comprises a near user edge device.

4. The system of claim 1, wherein the one or more agents are configured with at least one of a beacon signal measurer, a beacon address scanner and multi-sense sensor.

5. The system of claim 1, wherein the one or more agents are mobile.

6. The system of claim 1, wherein the one or more agents are connected as a star based configuration, a layer star based configuration, or a cornered agent configuration.

7. The system of claim 1, wherein the first routing device comprises a USB cable or a WiFi router.

8. The system of claim 1, wherein the second routing device comprises a USB cable or a WiFi router.

9. The system of claim 1, wherein the first routing device is connected on a point-to-point topology.

10. The system of claim 1, wherein the first routing device is connected on a multi-point topology.

11. The system of claim 1, wherein a user device is used as a reference.

12. A method for determining real-time spatial coordinates of a user device, the method comprising:
determining for a particular environment, the optimal placement of an agent to thereby map the spatial coordinates of the particular environment and correlate the location of the agent associated with the particular environment;
processing characterization data associated with user device to thereby perform data mining of a beacon configured with the user device and assign a tag to the beacon;
transmitting one or more commands towards the agent;
receiving from the agent data associated with the user device;
normalizing the data of the specific user device to thereby determine the real-time spatial coordinates based on the corresponding data associated with said user device; and
transmitting one or more commands towards the cloud server.

13. The method of claim 12, wherein a machine learning based real-time locating system performs an agent location and a zone division function to determine the optimal placement of the agent.

14. The method of claim 12, wherein determining the optimal placement of the agent further comprise one of a star based, layer star based and corner based functions.

15. The method of claim 13, wherein determining the optimal placement of the agent further comprises performing a real-time room/zone decision based on a received signal strength indication function.

16. The method of claim 12, wherein determining the optimal placement of the agent further comprises performing machine learning based procedures.

17. The method of claim 12, wherein the characterization data includes white list data and black list data.

18. The method of claim 12, further comprising acquiring data associated with a user device, the method comprising:
sensing a wireless signal transmitted towards the agent, said wireless signal associated with the beacon;
processing the characterization data associated with the user device and identifying a tag associated with the user device;
processing one or more commands a fog transmits towards the agent;
measuring a signal strength of said wireless signal and associating relative spatial coordinates to the corresponding data associated with the user device whose signal was measured;
transmitting toward the fog the data for the user device to thereby determine the real-time spatial coordinates of the user device.

19. The method of claim 12, wherein characterization data includes white list and black list data maintained in the cloud and beacon movement information for battery power management.
